(19) United States
(12) Patent Application Publication
(10) Pub. No.: US 2026/0285048 A1
(43) Pub. Date: Sep. 24, 2026

(54) INK REFILL CONTAINER AND INK REFILL CONTAINER REMANUFACTURING METHOD

(71) Applicant: CANON KABUSHIKI KAISHA, Tokyo (JP)

(72) Inventor: TAKURO INABA, Kanagawa (JP)

(21) Appl. No.: 19/574,037

(22) Filed: Mar. 20, 2026

(30) Foreign Application Priority Data
Mar. 24, 2025 (JP) 2025-049022

(51) Int. Cl. B41J 2/175

(52) U.S. Cl. CPC B41J 2/17509; B41J 2/17513

(57) ABSTRACT

An ink refill container for refilling an ejection apparatus that ejects ink with ink includes an ink container bag configured to contain ink and including a discharge port that allows the contained ink to be discharged, a container main body part configured to house the ink container bag, and a nozzle part including a communication port that communicates with the discharge port and configured to be attached to the container main body part via the ink container bag, wherein an elastic part is provided in a contact region where the nozzle part and the container main body part come into contact with each other via the ink container bag.

### BACKGROUND

### Field of the Technology

The present disclosure relates to an ink refill container and a remanufacturing method therefor.

### Description of the Related Art

Inkjet printers perform recording on recording media by ejecting ink from liquid ejection heads that eject ink onto the recording media such as paper. In an inkjet printer, a configuration is known in which liquid to be ejected from an inkjet head is stored in an ink tank of the main body of the inkjet printer. In this configuration, an ink refill container can refill the ink tank with ink. Such an ink refill container generally has a large ink capacity. Therefore, the ink refill container for refilling the ink tank of the apparatus main body with ink uses a smaller amount of plastic per unit of ink capacity, as compared with other ink cartridges and the like. That is, the ink refill container has an advantage of being environmentally friendly. Furthermore, in recent years, compliance with the 3Rs has been required in order to achieve a sustainable society, such as a decarbonized society/circular society. The 3Rs include “reuse” that refers to the repeated use of used products and parts thereof, “recycle” that refers to the effective utilization of waste as raw materials and energy sources, and “reduce” that refers to the reduction of the amount of waste.

As a technique for meeting such requirements, for example, Japanese Patent Laid-Open No. 2022-13034 describes a technique for reducing the volume of components to be discarded by reusing a part of a used ink refill container.

Specifically, Japanese Patent Laid-Open No. 2022-13034 describes an ink refill container that houses an ink container bag made of an elastic material in its container main body part. By storing ink inside the ink container bag, the container main body part does not come into contact with the ink. Thus, the container main body part can be easily reused by removing the ink container bag that has been in contact with the ink.

To facilitate ink refilling into the ink tank from the ink refill container, it is conceivable to provide a nozzle part that is attached to the container main body part via the ink container bag in the ink refill container described in Japanese Patent Laid-Open No. 2022-13034. In this case, the ink needs to be prevented from leaking from the gap between the ink container bag and the nozzle part. That is, good sealing performance needs to be achieved by close contact between the nozzle part and the container main body part via the ink container bag. However, the ink refill container described in Japanese Patent Laid-Open No. 2022-13034 does not have a configuration that ensures the sealing performance between the nozzle part and the container main body part via the ink container bag. Thus, there is a concern that the ink may leak from the gap between the ink container bag and the nozzle part.

Furthermore, after the ink container bag is removed from the used ink refill container, the distance between the nozzle part and the container main body part changes by the thickness of the ink container bag. Therefore, when the ink refill container is reused, the sealing performance between the nozzle part and the container main body part is lowered, and the ink may leak.

### SUMMARY

The present disclosure is directed to providing an ink refill container that has good sealing performance by close contact between a nozzle part and a container main body part and that is easy to reuse, and providing a remanufacturing method for the ink refill container.

According to an aspect of the present disclosure, an ink refill container for refilling an ejection apparatus that ejects ink with ink includes an ink container bag configured to contain ink and including a discharge port that allows the contained ink to be discharged, a container main body part configured to house the ink container bag, and a nozzle part including a communication port that communicates with the discharge port and configured to be attached to the container main body part via the ink container bag, wherein an elastic part is provided in a contact region where the nozzle part and the container main body part come into contact with each other via the ink container bag.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of an external appearance of an inkjet printer.

FIG. 2 is a perspective view of an internal configuration of the inkjet printer.

FIG. 3 is a perspective view of an ink supply system of the inkjet printer.

FIG. 4 schematically illustrates refilling a tank with ink from an ink refill container.

FIG. 5 is a schematic front view of the ink refill container.

FIG. 6 is a schematic sectional view of the ink refill container.

FIG. 7 is an enlarged view of the vicinity of a nozzle of the ink refill container.

FIG. 8 is an enlarged view of an elastic part.

FIG. 9 is a flowchart illustrating an ink refill container remanufacturing process.

FIG. 10 is a schematic sectional view of the ink refill container.

FIG. 11 is a flowchart illustrating an ink refill container remanufacturing process.

FIG. 12A illustrates a state before a first bag is removed from a container main body part, and FIG. 12B illustrates a state after the first bag is removed from the container main body part.

FIG. 13 is an enlarged view of the vicinity of a nozzle of an ink refill container.

FIG. 14 is an enlarged view of the vicinity of a contact region.

FIG. 15 is an enlarged view of the vicinity of a contact region.

### DESCRIPTION OF THE EMBODIMENTS

The embodiments of the present disclosure will be described below with reference to the drawings. It should be noted that the following embodiments do not limit the scope of the present disclosure, and not all combinations of features described in these embodiments are necessarily essential to the solutions of the present disclosure. In addition, identical components are denoted by the same reference numerals. Each of the embodiments of the present invention described below can be implemented solely or as a combination of a plurality of the embodiments or features thereof where necessary or where the combination of elements or features from individual embodiments in a single embodiment is beneficial.

### First Embodiment

### (Inkjet Printer)

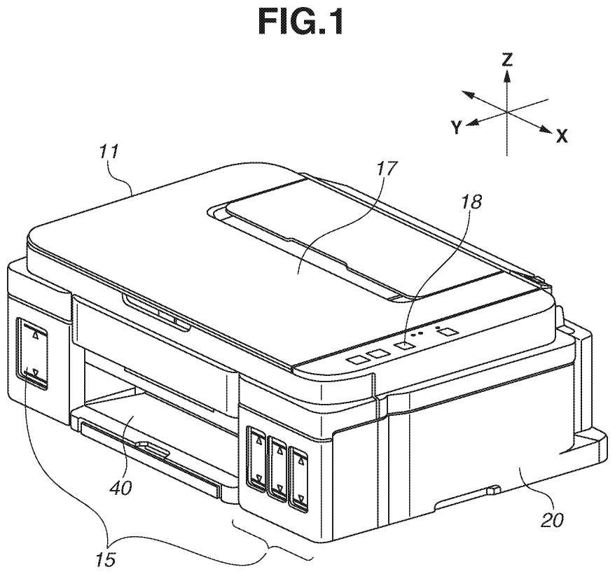

FIG. 1 is a perspective view of an overview of an inkjet printer 11 according to the present embodiment. The inkjet printer 11 according to the present embodiment is a recording apparatus that records an image on a recording medium by ejecting liquid ink from an inkjet head (hereinafter, referred to as “head”) onto the recording medium. The inkjet printer 11 is an example of a liquid ejection apparatus that ejects liquid.

The present embodiment will be described by using the inkjet printer 11 as an example. However, the liquid ejection apparatus according to the present disclosure is not limited to an inkjet printer, as long as a liquid tank of an apparatus main body can be refilled with liquid from a liquid refill container. Further, the ink refill container is not limited to a container used for ink refilling, as long as the ink refill container is capable of liquid refilling. However, the present disclosure is particularly suitable for an ink refill container used for ink refilling. This is because the ink refill container contains ink, and when the ink refill container is reused (remanufactured), a step such as cleaning is necessary, which makes it difficult to reuse the ink refill container.

In the following description, the width direction of the inkjet printer 11 is defined as the X direction, the depth direction is defined as the Y direction, and the direction perpendicular to the X direction and the Y direction is defined as the Z direction. When the inkjet printer 11 is installed on a horizontal surface, the Z direction is parallel to the vertical direction. As will be described below, the main scanning direction of the head is parallel to the X direction, and the conveyance direction of the recording medium is parallel to the Y direction.

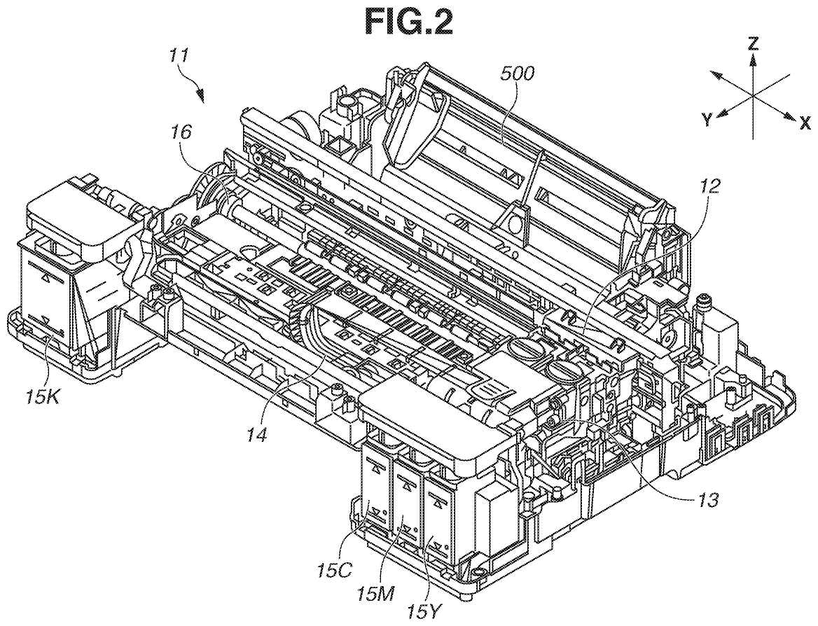

As illustrated in FIG. 1, the inkjet printer 11 includes a housing (exterior part) 20, a head 13 (see FIG. 2) that performs a recording operation on a recording medium (not illustrated), and ink tanks 15 as ink containers that contain ink to be supplied to the head 13. According to the present embodiment, the ink tanks 15 are disposed on the front side (the +Y direction side) of the housing 20 and fixed to the inkjet printer 11. Further, a scanner unit 17 that performs a document reading operation and an operation input unit 18 on which a user can perform an operation such as input of instructions are provided on the upper portion of the housing 20.

FIG. 2 is a perspective view of an internal configuration of the inkjet printer 11. The inkjet printer 11 includes a feeding unit 500 that feeds a recording medium, a conveyance roller 16 that conveys the recording medium, and a discharge unit 40 (see FIG. 1) that discharges the recording medium. The recording medium is fed from the feeding unit 500 to the inside of the inkjet printer 11 by rollers (not illustrated). The head 13 performs the recording operation on the fed recording medium while the recording medium is being conveyed by the conveyance roller 16. The recording medium on which recording has been completed is discharged from the discharge unit 40 to the outside of the inkjet printer 11. As described above, the direction (the Y direction) in which the recording medium is conveyed is referred to as “conveyance direction”.

A carriage 12 is moved by a drive source (not illustrated) along a main scanning direction (the X direction) crossing the conveyance direction of the recording medium. According to the present embodiment, the conveyance direction and the main scanning direction are perpendicular to each other.

The head 13 is mounted on the carriage 12, and performs the recording operation in which the head 13 records one band of image on the recording medium by ejecting ink droplets while moving in the main scanning direction.

According to the present embodiment, the head 13 is, as an example, a serial head that is mounted on the carriage 12 and ejects ink while moving in the main scanning direction. However, the head 13 is not limited to the serial head. In other words, the head 13 may be a line head that is mounted on the carriage 12 and is capable of ejecting ink over the entire region in the width direction (the X direction) of the recording medium without scanning by the carriage 12.

When one band of image is recorded on the recording medium, the recording medium is conveyed by a predetermined amount in the conveyance direction by the conveyance roller 16 (an intermittent conveyance operation). By repeating the recording operation for one band and the intermittent conveyance operation, an image is recorded on the entire recording medium.

Further, the inkjet printer 11 includes a maintenance unit that performs maintenance of the head 13 in a movement region in the main scanning direction of the carriage 12.

The inkjet printer 11 has the ink tanks 15, each of which contains ink of a different color for recording. As illustrated in FIG. 2, the inkjet printer 11 includes a black ink tank 15K for black ink, a cyan ink tank 15C for cyan ink, a magenta ink tank 15M for magenta ink, and a yellow ink tank 15Y for yellow ink.

Hereinafter, when description can be made without distinguishing the ink colors from each other, that is, when a common configuration is described regardless of the ink colors, any ink tank may be simply referred to as “ink tank 15” by omitting the characters Y, M, C, and K, which indicate the ink colors.

The black ink tank 15K is provided on the left side of the discharge unit 40 when viewed from the front side (the +Y direction side) of the inkjet printer 11. The ink tanks for the other color inks (the cyan ink tank 15C, the magenta ink tank 15M, and the yellow ink tank 15Y) are provided on the right side of the discharge unit 40 when viewed from the front side of the inkjet printer 11. The discharge unit 40 is provided between the black ink tank 15K and the ink tanks for the other color inks.

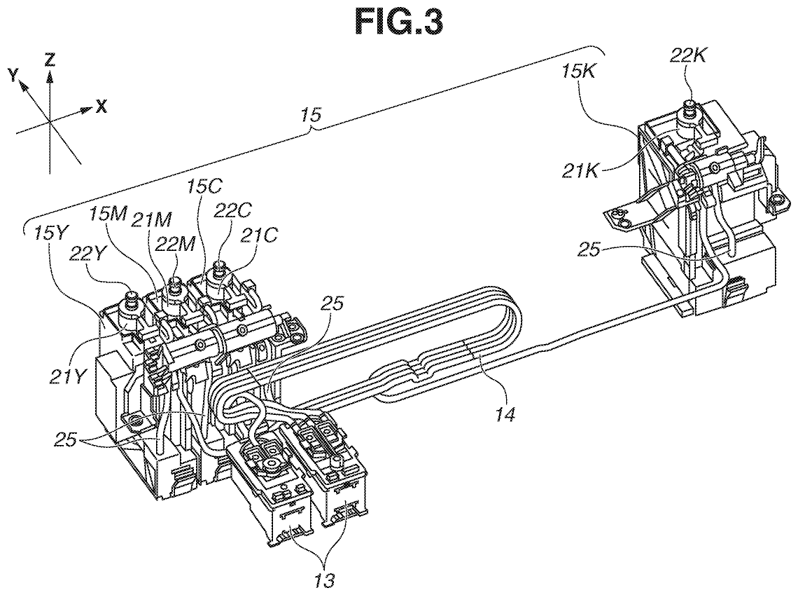

FIG. 3 is a perspective view of an ink supply system of the inkjet printer 11, viewed from the rear side (the −Y direction side). An ink tank 15 is provided for each ink color. A flexible tube forming an ink supply path 14 (an ink flow path) for supplying ink to the head 13 is attached to the individual ink tank 15.

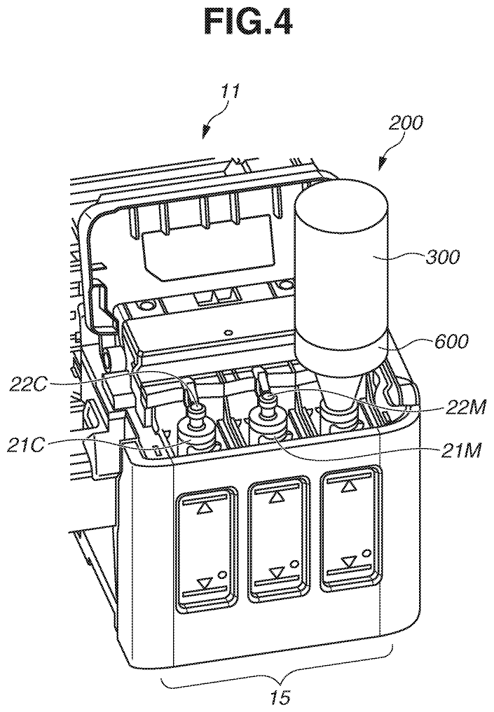

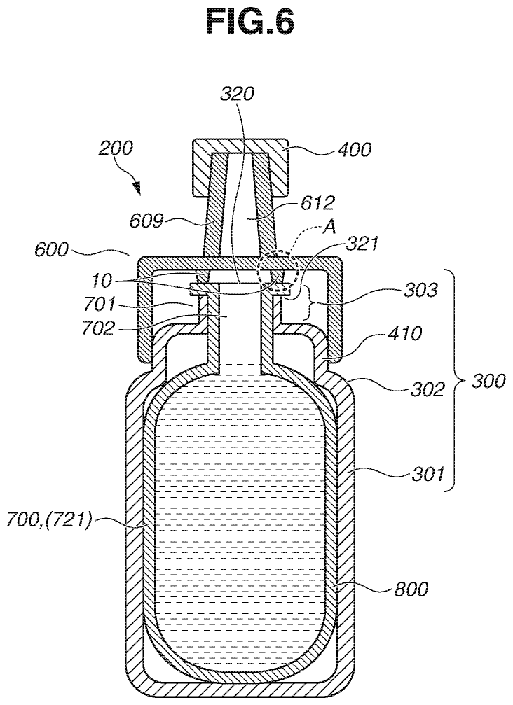

Further, a flexible tube forming an air communication passage for communicating the inside of the ink tank 15 with the atmosphere is attached to the individual ink tank 15. FIG. 4 is a perspective view of refilling of ink 800 (see FIG. 6) into the ink tank 15 of the inkjet printer 11 from an ink refill container 200 (an ink bottle).

A refill port 22 through which the user injects ink into the ink tank 15 is provided in an upper portion of the ink tank 15. The refill port 22 is open in a direction having a vertical component. The ink injected (refilled) through the refill port 22 is stored in a tank portion 21 of the ink tank 15. A cap (a tank cap) (not illustrated) for sealing the refill port 22 is detachably attached to the refill port 22. The user can inject ink from the ink refill container 200 into the ink tank 15 by detaching the cap and connecting a nozzle part 600 of the ink refill container 200 to the refill port 22.

### (Ink Refill Container)

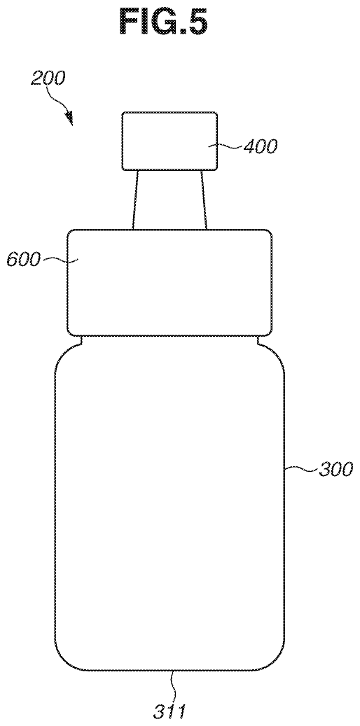

FIG. 5 is a front view of the ink refill container 200 in an upright state. The upright state refers to a state in which a bottom portion 311 of the ink refill container 200 is placed on a horizontal surface. The ink refill container 200 includes a container main body part 300, the nozzle part 600, and a cap 400.

The container main body part 300 houses an ink container bag 700 (FIG. 6), which will be described below, such that ink can be discharged from a discharge port 702 of the ink container bag 700. The nozzle part 600 is detachably attached to the container main body part 300. By connecting the tip portion of the nozzle part 600 to the refill port 22 of the ink tank 15, the ink in the container main body part 300 is injected into the ink tank 15 via the nozzle part 600. In this way, the ink tank 15 can be refilled with the ink from the ink refill container 200. The cap 400 is attachable to and detachable from the tip portion of the nozzle part 600, seals the opening of the nozzle part 600 by being attached to the nozzle part 600, and opens the opening of the nozzle part 600 by being detached from the nozzle part 600.

FIG. 6 is a sectional view of an internal configuration of the ink refill container 200. The container main body part 300 has a cylindrical portion 301, a shoulder portion 302, and a neck portion 303 in this order from the bottom in an upright state. The cylindrical portion 301 has a bottomed cylindrical shape. The direction in which the cylindrical shape extends is referred to as “axial direction” (also referred to as “longitudinal direction”) of the container main body part 300 and the ink refill container 200, and a direction perpendicular to the axial direction (a first direction) is referred to as “radial direction” (a second direction). The axial direction is parallel to the vertical direction in an upright state.

The shape of the bottom portion 311 may be a circular shape, a rectangular shape, a polygonal shape, or the like, and is not particularly limited. The shoulder portion 302 having an inner diameter and an outer diameter that are smaller than those of the cylindrical portion 301 is provided on a side of the cylindrical portion 301 opposite to the bottom portion 311. The neck portion 303 having an inner diameter and an outer diameter that are smaller than those of the shoulder portion 302 is provided on a side of the shoulder portion 302 opposite to the cylindrical portion 301. An opening 320 is formed in the neck portion 303 on the opposite side of the shoulder portion 302 such that the ink in the container main body part 300 can flow out to the outside. As will be described below, the opening 320 also serves as an opening for storing the ink container bag 700 inside the container main body part 300. The opening 320 is formed by an opening portion 321.

The container main body part 300 houses the ink container bag 700 that contains ink and has the discharge port 702 through which the contained ink can be discharged. According to the first embodiment, the ink container bag 700 is constituted by a first bag 721. The ink 800 is contained in the first bag 721. The container main body part 300 can house the ink container bag 700 such that the ink 800 can be discharged from the discharge port 702.

The first bag 721 is made of a resin material such as polypropylene or polyethylene, and can be manufactured by blow molding. In addition, it is desirable that the ink container bag 700 be made of an elastic material.

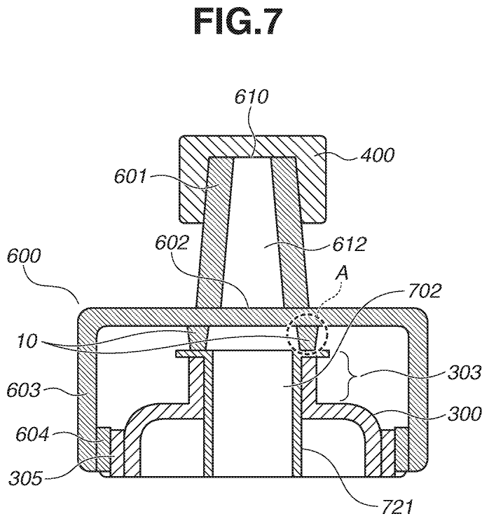

FIG. 7 is an enlarged view of the vicinity of the nozzle part 600 in FIG. 6. The nozzle part 600 is attachable to and detachable from the container main body part 300. The nozzle part 600 includes a container attachment part 603 that is detachably attached to the container main body part 300, and a cap attachment part 609 to which the cap 400 is detachably attached. The container attachment part 603 is attachable to and detachable from the shoulder portion 302 of the container main body part 300, for example. The nozzle part 600 is attached to the container main body part 300 by fixing the container attachment part 603 to the shoulder portion 302, and the nozzle part 600 is detached from the container main body part 300 by detaching the container attachment part 603 from the shoulder portion 302.

A helical external thread (male thread) 604 is formed on the inner circumferential surface of the container attachment part 603 of the nozzle part 600, and a helical internal thread (female thread) 305 is formed on the outer circumferential surface of the shoulder portion 302 of the container main body part 300. The nozzle part 600 can be attached to the container main body part 300 by screwing the nozzle part 600 onto the container main body part 300 by rotating the nozzle part 600 in an attaching direction (leftward direction) while keeping the external thread 604 and the internal thread 305 engaged. The nozzle part 600 can be detached from the container main body part 300 by rotating the nozzle part 600 in a detaching direction (rightward direction) opposite to the leftward direction with respect to the container main body part 300 while keeping the external thread 604 and the internal thread 305 engaged. The rotational directions for attaching (the leftward direction) and detaching (the rightward direction) the nozzle may be reversed.

Further, the nozzle part 600 includes a communication port 602 communicating with the discharge port 702 of the ink container bag 700 and an opening 610 that opens the communication port 602 to the outside. The opening 610 is formed in a tip portion 601 of the cap attachment part 609. The tip portion 601 has a shape that allows the tip portion 601 to be connected to the refill port 22 of the ink tank 15. A communication passage 612 through which ink can flow is formed inside the cap attachment part 609. The communication passage 612 communicates with the discharge port 702 via the communication port 602 when the nozzle part 600 is attached to the container main body part 300. The ink in the container main body part 300 flows to the opening 610 via the discharge port 702, the communication port 602, and the communication passage 612, and the ink discharged from the opening 610 is supplied to the ink tank 15.

In the ink refill container 200 according to the present embodiment, an end portion 701 of the ink container bag 700 housed in the container main body part 300 is attached onto the opening portion 321 of the container main body part 300. Thus, when the nozzle part 600 is attached to the container main body part 300, the nozzle part 600 and the container main body part 300 come into contact with each other via the ink container bag 700. In this case, good sealing performance between the nozzle part 600 and the container main body part 300 via the ink container bag 700 is required. When the sealing performance is poor, the ink may leak from the ink refill container 200, which leads to contamination of the ink refill container 200. As a result, more labor such as cleaning is needed, and this raises a concern about an increase in an environmental load. Further, if the ink is discharged from the ink refill container 200 to the outside in a situation not intended by the user, the discharged ink may have a great impact on the outside.

Thus, in the ink refill container 200 according to the present embodiment, an elastic part 10 is provided in a contact region A where the nozzle part 600 and the container main body part 300 come into contact with each other via the ink container bag 700. Due to the elastic part provided in the contact region A, when the nozzle part 600 is pressed onto the container main body part 300, the elastic part 10 is compressed. As a result, the sealing performance between the nozzle part 600 and the container main body part 300 via the ink container bag 700 is improved. This can reduce the possibility of ink leakage from the gap between the ink container bag 700 and the nozzle part 600.

In the ink refill container 200 according to the present embodiment, the elastic part 10 is provided on the nozzle part 600. The elastic modulus of the elastic part 10 is desirably equal to or greater than the elastic modulus of the nozzle part 600. In this way, the amount of compression of the elastic part 10 can be stabilized, and the sealing performance between the nozzle part 600 and the container main body part 300 via the ink container bag 700 can be further improved.

The elastic modulus of the nozzle part 600 may be an average elastic modulus of the entire nozzle part 600, or may be an average elastic modulus in the vicinity of a portion of the nozzle part 600 where the elastic part 10 is provided.

Furthermore, the elastic part 10 is desirably provided at a position that circumferentially surrounds the communication port 602 of the nozzle part 600. That is, the elastic part 10 is desirably provided in the entire region A where the nozzle part 600 and the container main body part 300 come into contact with each other via the ink container bag 700.

In this way, the sealing performance between the nozzle part 600 and the container main body part 300 is further improved when the nozzle part 600 is screwed onto the container main body part 300.

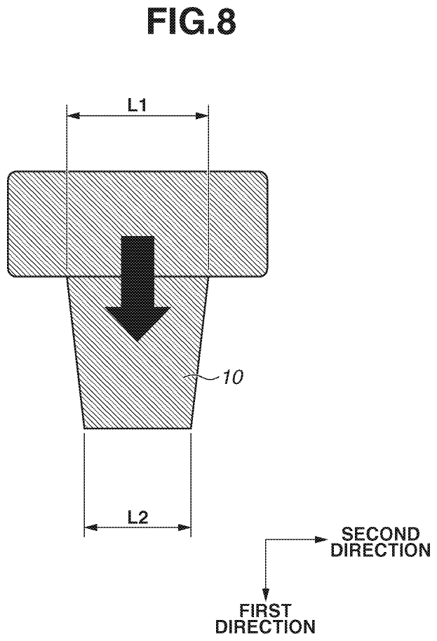

FIG. 8 is an enlarged view of the elastic part 10 having a suitable shape. When the nozzle part 600 comes into contact with the container main body part 300 via the elastic part 10, pressure is applied to the elastic part 10 in the direction of the arrow illustrated in FIG. 8. Thus, a surface of the elastic part 10 that comes into contact with the opening portion 321 via the ink container bag 700 is compressed. As a result, the gap between the nozzle part 600 and the ink container bag 700 is sealed. To further improve the sealing force, ideally, it is desirable that pressure be applied uniformly to, and compress, the entire contact surface of the elastic part 10. Therefore, when the length of the elastic part 10 in the radial direction on the base side is L1 and the length of the elastic part 10 in the radial direction on the distal end side is L2, L1 is desirably equal to or greater than L2 (L1≥L2). In other words, the elastic part 10 desirably includes a portion that extends from the nozzle part 600 in the first direction in which the nozzle part 600 is pressed onto the opening portion 321, and the length of the portion in a direction perpendicular to the first direction decreases as the elastic part 10 extends in the first direction.

The elastic part 10 may be a separate component from the nozzle part 600, and may be a component such as an O-ring. Rubber, an elastomer, a spring, or the like can be used as the material of the elastic part 10.

The attachment and detachment mechanism between the nozzle part 600 and the container main body part 300 is not limited to the screwing mechanism described above, and may be, for example, an engagement mechanism between an engaging portion and an engaged portion, or a fitting mechanism between a fitting portion and a fitted portion.

In the ink refill container 200 according to the present embodiment, the elastic part 10 is formed on the nozzle part 600; however, the elastic part 10 may be formed on the container main body part 300. In this case, the elastic part 10 is formed in the region where the nozzle part 600 and the container main body part 300 come into contact with each other via the ink container bag 700, that is, in the opening portion 321 of the container main body part 300. Even in this case, when the nozzle part 600 is attached to the container main body part 300, the elastic part 10 is compressed, and as a result, the sealing force between the nozzle part 600 and the container main body part 300 via the ink container bag 700 can be improved.

In this case, the elastic modulus of the elastic part 10 is desirably equal to or greater than the elastic modulus of the container main body part 300. In this way, the amount of compression of the elastic part 10 can be stabilized, and the sealing performance between the nozzle part 600 and the container main body part 300 via the ink container bag 700 can be further improved. The elastic modulus of the container main body part 300 indicates the elastic modulus of a portion of the container main body part 300 where the elastic part 10 is provided, that is, the elastic modulus in the vicinity of the opening portion 321.

The elastic part 10 may be formed as a portion of the ink container bag 700. In other words, the elastic part 10 may be provided at a portion of the ink container bag 700 that corresponds to the region A where the nozzle part 600 and the container main body part 300 come into contact with each other via the ink container bag 700. Even in this case, when the nozzle part 600 is attached to the container main body part 300, the elastic part 10 is compressed, and as a result, the sealing force between the nozzle part 600 and the container main body part 300 via the ink container bag 700 can be improved.

In this case, the elastic modulus of the elastic part 10 is desirably equal to or greater than the elastic modulus of the ink container bag 700. In this way, the amount of compression of the elastic part 10 can be stabilized, and the sealing performance between the nozzle part 600 and the container main body part 300 via the ink container bag 700 can be further improved. The elastic modulus of the ink container bag 700 here indicates the elastic modulus in the vicinity of the portion of the ink container bag 700 where the elastic part 10 is provided.

As described above, in the ink refill container 200 according to the present embodiment, even in a configuration in which the container main body part 300 houses the ink container bag 700, the elastic part 10 ensures the sealing performance between the nozzle part 600 and the container main body part 300 via the ink container bag 700. Therefore, the possibility of ink leakage from the gap between the nozzle part 600 and the ink container bag 700 can be reduced.

### (Ink Refill Container Remanufacturing Method)

Next, a method of reusing (remanufacturing) an ink refill container using a used ink refill container will be described. Here, the used ink refill container refers to an ink refill container that includes the ink container bag 700, the container main body part 300, and the nozzle part 600, and in which the elastic part 10 is provided in the region where the nozzle part 600 and the container main body part 300 come into contact with each other via the ink container bag 700. The used ink refill container indicates an ink refill container 200 in which the ink in the ink container bag 700 has been consumed. Examples of the used ink refill container include an ink refill container 200 in which the ink inside the ink container bag 700 has completely been consumed and an ink refill container 200 in which a small amount of ink remains in the ink container bag 700. Alternatively, the used ink refill container may be an ink refill container 200 that has become unusable even without being opened.

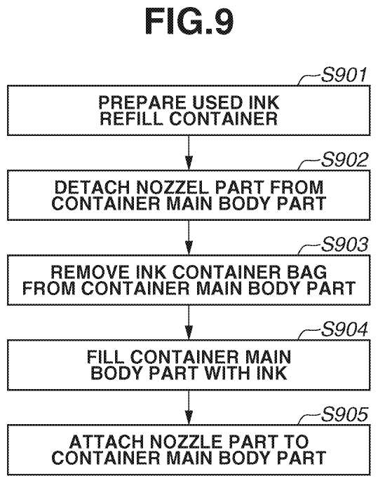

FIG. 9 is a flowchart illustrating a method of remanufacturing an ink refill container 200.

First, in step S901, a used ink refill container is prepared. This preparation step corresponds to, for example, an act of collecting a used ink refill container.

Next, in step S902, the nozzle part 600 is detached from the container main body part 300.

In the ink refill container 200 according to the present embodiment, the nozzle part 600 can be detached from the container main body part 300 by rotating the nozzle part 600 in a detaching direction, which is opposite to the attaching direction, with respect to the container main body part 300.

Next, in step S903, the ink container bag 700 is removed from the container main body part 300. Ink is attached to the inside of the ink container bag 700. When the ink container bag 700 is removed from the container main body part 300, the inside of the container main body part 300 is exposed. In this case, the ink is not attached to the inside of the container main body part 300, and therefore, there is no need to, for example, clean the inside of the container main body part 300 when the container main body part 300 is newly filled with ink. Thus, an ink refill container 200 can be easily remanufactured by using the used ink refill container. The inside of the container main body part 300 may be cleaned to remove foreign matter, etc. that have entered the container main body part 300. Even in this case, the cleaning process is easier than in the case where the ink is attached to the inside of the container main body part 300. Thus, an ink refill container 200 can be easily remanufactured by using the used ink refill container.

Next, in step S904, the container main body part 300 is filled with ink via the opening 320. The type of ink with which the container main body part 300 is filled is desirably the same as that contained in the ink container bag 700.

Finally, in step S905, the nozzle part 600 is attached to the container main body part 300. The nozzle part 600 is attached such that the nozzle part 600 and the container main body part 300 come into contact with each other via the elastic part 10. In this way, even when the thickness dimension is reduced by the thickness of the removed ink container bag 700, the sealing performance between the nozzle part 600 and the container main body part 300 can be improved. Although the nozzle part 600 is desirably reused from the viewpoint of environmental protection, a new nozzle part 600 to which no ink is attached may be used.

According to the present embodiment, after the ink container bag 700 is removed in step S903, the container main body part 300 is filled with ink in step S904. However, an ink container bag different from the ink container bag that has been removed in step S903 may be housed after step S903. In this case, a step of filling ink into the inside of the new ink container bag is performed, instead of performing step S904. Even when the ink container bag is replaced with a new ink container bag, the container main body part 300 can be reused, thereby reducing an environmental load. Further, because the elastic part 10 is provided, good sealing performance is achieved between the container main body part 300 and the nozzle part 600 via the new ink container bag.

By performing the steps described above, an ink refill container 200 can be remanufactured by using the used ink refill container.

By using the ink refill container remanufacturing method according to the present embodiment, even the remanufactured ink refill container 200 can ensure the sealing performance between the nozzle part 600 and the container main body part 300. Thus, ink leakage is prevented, and the ink refill container 200 can be easily remanufactured.

The ink refill container remanufacturing process may include other steps, as long as the process includes steps S901 to S905 described above.

### Second Embodiment

### (Ink Refill Container)

A configuration of an ink refill container 200 according to a second embodiment will be described. In the following description, only the portions that differ from the first embodiment will mainly be described, and description of the similar portions to those according to the first embodiment will be omitted.

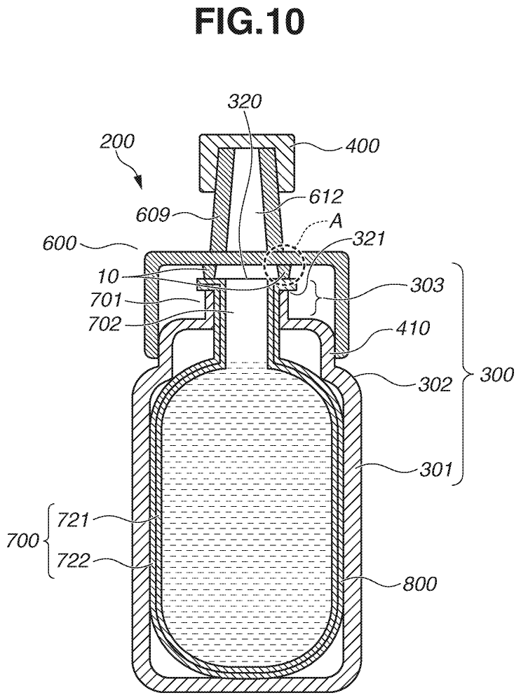

FIG. 10 is a sectional view of an internal configuration of the ink refill container 200 according to the second embodiment. The ink refill container 200 according to the second embodiment differs from that according to the first embodiment in that an ink container bag 700 includes a first bag 721 that contains ink and a second bag 722 that houses the first bag 721. The second bag 722 may not necessarily house the entire surface of the first bag 721, and an end portion 701 of the first bag 721 may protrude from the second bag 722.

The first bag 721 and the second bag 722 are arranged such that the first bag 721 and the second bag 722 overlap each other in a nested manner. The bag located on the outermost side of the ink container bag 700 is at least partially attached to the inner surface of the container main body part 300. According to the present embodiment, the bag located on the outermost side of the ink container bag 700 is the second bag 722, and the second bag 722 is at least partially attached to the inner surface of the container main body part 300.

The first bag 721 and the second bag 722 are both made of a resin material such as polypropylene or polyethylene, and can be collectively manufactured by, for example, multilayer blow molding. In the case of manufacturing by the multilayer blow molding, the bags adjacent to each other, such as the first bag 721 and the second bag 722, need to be incompatible with each other so that they do not become fused together during the molding. Thus, the first bag 721 and the second bag 722 are desirably made of different materials.

In addition, in the case where the first bag 721 and the second bag 722 are not collectively manufactured by the multilayer blow molding, that is, in the case where the first bag 721 and the second bag 722 are separately manufactured, the first bag 721 and the second bag 722 may be made of the same material. In this case, the ink container bag 700 is manufactured by overlapping the first bag 721 and the second bag 722, which have been manufactured separately.

Even in the case where the ink container bag 700 includes the first bag 721 and the second bag 722 as in the ink refill container 200 according to the second embodiment, ink leakage from the gap between a nozzle part 600 and the ink container bag 700 can be prevented, as long as an elastic part 10 is provided in a contact region A.

The second embodiment has been described based on an example in which the ink container bag 700 includes the first bag 721 and the second bag 722. However, a third bag and a fourth bag may be further provided on the outer side of the second bag 722. That is, the number of bags included in the ink container bag 700 is not particularly limited.

### (Ink Refill Container Remanufacturing Method)

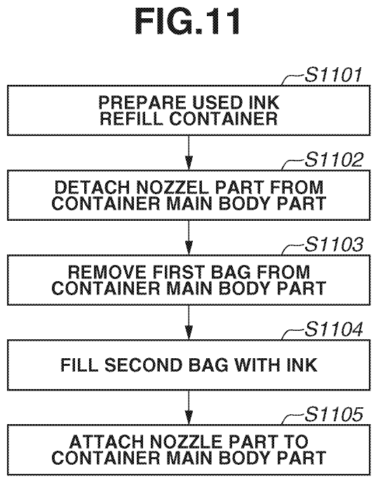

A method of remanufacturing the ink refill container 200 according to the second embodiment will be described. FIG. 11 is a flowchart illustrating an ink refill container remanufacturing method according to the second embodiment.

First, in step S1101, a used ink refill container is prepared. The used ink refill container according to the second embodiment includes the ink container bag 700 including the first bag 721 and the second bag 722, the container main body part 300, and the nozzle part 600, and the elastic part 10 is provided in a region where the nozzle part 600 and the container main body part 300 come into contact with each other via the ink container bag 700. The used ink refill container indicates an ink refill container 200 in which the ink in the first bag 721 has been consumed.

Next, in step S1102, the nozzle part 600 is detached from the container main body part 300. Step S1102 is the same as step S902.

Next, in step S1103, the first bag 721 is removed from the container main body part 300. Ink is attached to the inside of the first bag 721. When the first bag 721 is removed from the container main body part 300, the inside of the second bag 722 is exposed. In this case, the ink is not attached to the inside of the second bag 722, and therefore, there is no need to, for example, clean the inside of the second bag 722 when the second bag 722 is newly filled with ink. Thus, an ink refill container 200 can be easily remanufactured by using the used ink refill container. The inside of the second bag 722 may be cleaned to remove foreign matters, etc. that have entered the second bag 722. Even in this case, the cleaning process is easier than in the case where the ink is attached to the inside of the second bag 722. Thus, an ink refill container 200 can be easily remanufactured by using the used ink refill container.

Next, in step S1104, the second bag 722 is filled with ink. The type of ink with which the second bag 722 is filled is desirably the same as that contained in the first bag 721. When the first bag 721 is removed and the second bag 722 is filled with ink, the capacity of the second bag 722 is larger than that of the first bag 721, and thus, the amount of the contained ink that can evaporate increases. Therefore, in the step of filling the second bag 722 with ink, the second bag 722 is desirably filled with the amount of ink greater than the amount of ink contained in the first bag 721 of the unopened ink refill container 200.

Finally, in step S1105, the nozzle part 600 is attached to the container main body part 300. According to the present embodiment, the elastic part 10 is provided at a portion where the nozzle part 600 and the container main body part 300 come into contact with each other via the second bag 722. Therefore, even after the first bag 721 is removed, the sealing performance between the nozzle part 600 and the container main body part 300 is ensured. This will be described in detail below.

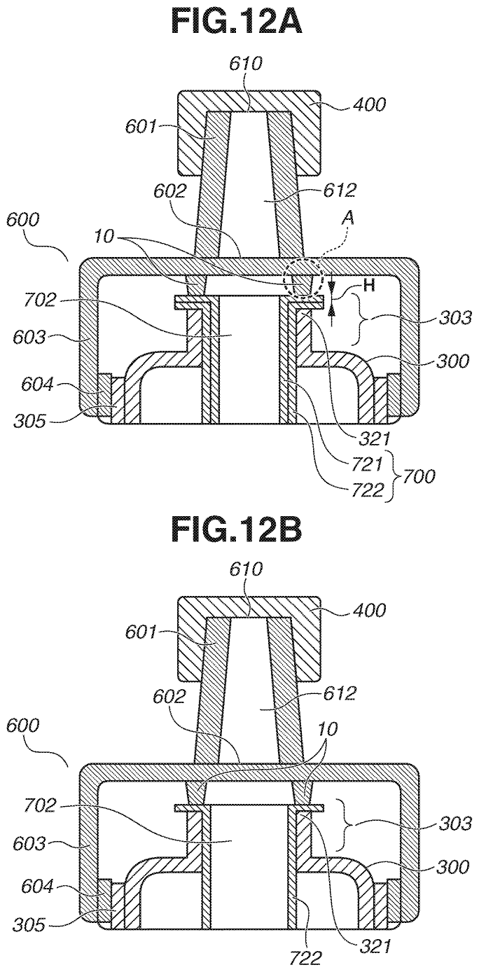

FIGS. 12A and 12B are enlarged views of the vicinity of the nozzle part 600 of the ink refill container 200 according to the second embodiment. FIG. 12A illustrates a state before the first bag 721 is removed from the container main body part 300, and FIG. 12B illustrates a state after first bag 721 is removed from the container main body part 300.

Assuming that the thickness of the first bag 721 is represented by H as illustrated in FIG. 12A, in a case where the elastic part 10 is not provided, the nozzle part 600 and the container main body part 300 are separated from each other by the thickness of H after step S1103, as compared with the state before step S1103. Therefore, there is a possibility of ink leakage from the gap between the nozzle part 600 and the container main body part 300 (the second bag 722).

On the other hand, in the case where the elastic part 10 is provided and the elastic part 10 is compressed by the container main body part 300, even if the nozzle part 600 and the container main body part 300 are separated from each other by a thickness of H by removing the first bag 721, the nozzle part 600 and the container main body part 300 can be brought into contact with each other via the second bag 722. Thus, no gap is formed between the nozzle part 600 and the container main body part 300 (the second bag 722), and ink leakage can be prevented. Furthermore, in a configuration in which the nozzle part 600 can be rotated and screwed onto the container main body part 300, by further screwing the nozzle part 600 onto the container main body part 300 by a thickness of H, the amount of compression of the elastic part 10 can be maintained at a certain level or more. As a result, stable sealing performance can be maintained.

By performing steps S1101 to S1105 described above, an ink refill container 200 can be remanufactured by using the used ink refill container.

As described above, in a configuration in which the first bag 721 is removed from the container main body part 300 of the used ink refill container and the second bag 722 is filled with ink, the sealing performance between the nozzle part 600 and the container main body part 300 via the second bag 722 becomes an issue. In the ink refill container 200 according to the present embodiment, since the elastic part 10 is provided in the above-described contact region, even when the thickness dimension of the ink container bag 700 changes, good sealing performance is achieved between the nozzle part 600 and the container main body part 300 via the second bag 722. Thus, even when an ink refill container 200 is remanufactured, ink leakage is prevented. Therefore, by using the ink refill container 200 and the remanufacturing method therefor according to the present embodiment, the ink refill container 200 can be easily reused.

### Third Embodiment

A configuration of an ink refill container 200 according to a third embodiment will be described. In the following description, only the portions that differ from the first and second embodiments will mainly be described, and description of the similar portions to those according to the first and second embodiments will be omitted.

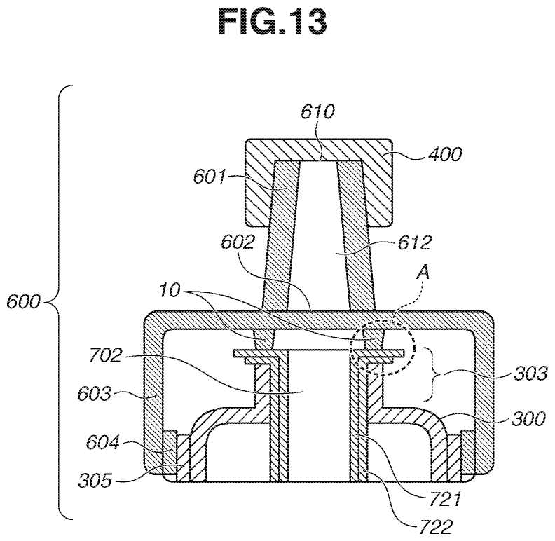

FIG. 13 is an enlarged view of the vicinity of a nozzle part 600 of the ink refill container 200 according to the third embodiment. As in the second embodiment, a first bag 721 and a second bag 722 overlap each other in the above-described contact region A.

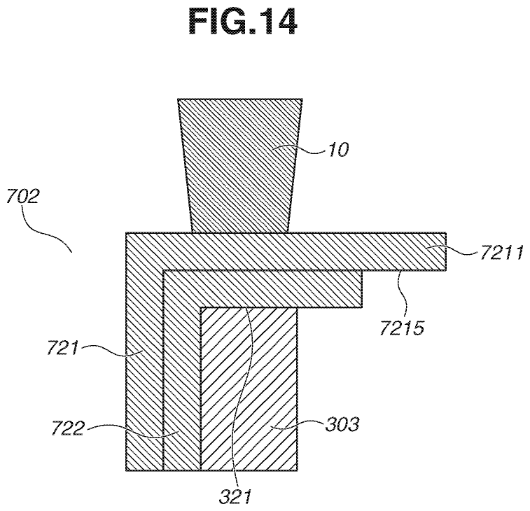

FIG. 14 is an enlarged view of the contact region A of the ink refill container 200 according to the third embodiment.

According to the third embodiment, an end portion 7211 of the first bag 721, which is located further away from a discharge port 702 than the contact region A, includes a region 7215 that does not overlap the second bag 721. Thus, in the ink refill container remanufacturing process, when the first bag 721 is removed from a container main body part 300, by holding the end portion 7211 of the first bag 721 and peeling off the first bag 721 from the second bag 722, only the first bag 721 can be easily removed without entangling the second bag 722. That is, according to the third embodiment, an ink refill container 200 that is easy to reuse can be provided. The ink refill container remanufacturing method according to the third embodiment is the same as the ink refill container remanufacturing method according to the second embodiment.

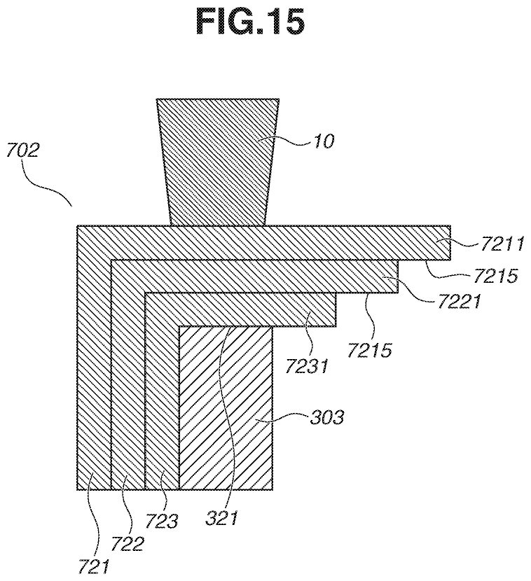

An ink container bag 700 according to the third embodiment may include a third bag and a fourth bag in addition to the first bag 721 and the second bag 722. FIG. 15 is an enlarged view of the contact region A of the ink refill container 200 provided with the ink container bag 700 that includes a third bag 723. The third bag 723 houses the second bag 722 therein. The third bag 723 may not necessarily house the entire surface of the second bag 722, and an end portion 7221 of the second bag 722 may protrude from the third bag 723. In the ink refill container 200 illustrated in FIG. 15, the end portion 7221 of the second bag 722, which is located further away from the discharge port 702 than the contact region A, includes a region 7215 that does not overlap the third bag 723. In other words, a region 7215 where adjacent bags do not at least partially overlap is provided between the bags. In this way, after an ink refill container 200 is remanufactured once and the first bag 721 is removed from the container main body part 300, an ink refill container 200 can be easily remanufactured again. In other words, when the second bag 722 is removed from the container main body part 300, by holding the end portion 7221 of the second bag 722 and peeling off the second bag 722 from the third bag 723, only the second bag 722 can be easily removed without entangling the third bag 723. That is, an ink refill container 200 that is easy to reuse a plurality of times can be provided.

In a case where the ink container bag 700 includes a plurality of bags, the innermost bag is used first. Thus, separation of a used ink container bag is performed in order from the innermost bag. Therefore, to provide a region where adjacent bags do not at least partially overlap each other, the length of the end portion of an inner bag is desirably longer than the length of the end portion of an outer bag in the radial direction of the discharge port 702.

The ink refill container 200 according to the third embodiment has a region where adjacent ink container bags do not at least partially overlap each other. By using this region, only the used ink container bag to be removed is easily held and peeled off. Thus, an ink refill container 200 that is easy to reuse can be provided.

As described above, the present disclosure provides an ink refill container that achieves good sealing performance by close contact between a nozzle part and a container main body part and that is easy to reuse, and provides an ink refill container remanufacturing method. That is, the technologies described in this specification have the potential to contribute to the achievement of a sustainable society, such as a decarbonized society/circular society.

The present disclosure provides an ink refill container that achieves good sealing performance by close contact between a nozzle part and a container main body part and that is easy to reuse, and provides an ink refill container remanufacturing method.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-049022, filed Mar. 24, 2025, which is hereby incorporated by reference herein in its entirety.

What is claimed is:

1. An ink refill container for refilling an ejection apparatus that ejects ink with ink, the ink refill container comprising:
an ink container bag configured to contain ink and including a discharge port that allows the contained ink to be discharged;
a container main body part configured to house the ink container bag; and
a nozzle part including a communication port that communicates with the discharge port and configured to be attached to the container main body part via the ink container bag,
wherein an elastic part is provided in a contact region where the nozzle part and the container main body part come into contact with each other via the ink container bag.

2. The ink refill container according to claim 1, wherein the elastic part is provided on the nozzle part.

3. The ink refill container according to claim 2, wherein an elastic modulus of the elastic part is equal to or greater than an elastic modulus of the nozzle part.

4. The ink refill container according to claim 2, wherein the elastic part is provided at a position that circumferentially surrounds the communication port of the nozzle part.

5. The ink refill container according to claim 1, wherein the ink container bag includes a first bag that contains the ink and a second bag that houses the first bag.

6. The ink refill container according to claim 5, wherein the first bag and the second bag are made of a same material.

7. The ink refill container according to claim 5, wherein the first bag and the second bag are made of different materials.

8. The ink refill container according to claim 5, wherein the first bag and the second bag overlap each other in the contact region.

9. The ink refill container according to claim 5, wherein an end portion of the first bag, which is located further away from the discharge port than the contact region, includes a region that does not overlap the second bag.

10. The ink refill container according to claim 1,
wherein the container main body part includes an opening portion that forms an opening for storing the ink container bag inside the container main body part, and
wherein the contact region is located above the opening portion.

11. The ink refill container according to claim 10, wherein the elastic part extends from the nozzle part in a first direction in which the nozzle part is pressed into the opening portion.

12. The ink refill container according to claim 11, wherein the elastic part include a portion whose length in a second direction perpendicular to the first direction decreases as the elastic part extends in the first direction.

13. The ink refill container according to claim 1, wherein the elastic part is provided on the container main body part.

14. The ink refill container according to claim 13, wherein an elastic modulus of the elastic part is equal to or greater than an elastic modulus of the container main body part.

15. The ink refill container according to claim 1, wherein the elastic part is provided on the ink container bag.

16. The ink refill container according to claim 15, wherein an elastic modulus of the elastic part is equal to or greater than an elastic modulus of the ink container bag.

17. An ink refill container remanufacturing method for remanufacturing an ink refill container for refilling an ejection apparatus that ejects ink with ink by using a used ink refill container,
wherein the used ink refill container includes:
an ink container bag configured to contain ink and including a discharge port that allows the contained ink to be discharged;
a container main body part configured to house the ink container bag; and
a nozzle part including a communication port that communicates with the discharge port and configured to be attached to the container main body part via the ink container bag, and
wherein an elastic part is provided in a contact region where the nozzle part and the container main body part come into contact with each other via the ink container bag,
the ink refill container remanufacturing method comprising:
preparing the used ink refill container;
detaching the nozzle part from the container main body part;
removing the ink container bag from the container main body part;
filling the container main body part with ink; and
attaching the nozzle part to the container main body part,
wherein the attaching includes attaching the container main body part and the nozzle part to each other via the elastic part.

18. An ink refill container remanufacturing method for remanufacturing an ink refill container for refilling an ejection apparatus that ejects ink with ink by using a used ink refill container,
wherein the used ink refill container includes:
an ink container bag configured to contain ink and including a discharge port that allows the contained ink to be discharged;
a container main body part configured to house the ink container bag; and
a nozzle part including a communication port that communicates with the discharge port and configured to be attached to the container main body part via the ink container bag,
wherein the ink container bag includes a first bag capable of containing ink and a second bag that houses the first bag, and
wherein an elastic part is provided in a contact region where the nozzle part and the container main body part come into contact with each other via the ink container bag,
the ink refill container remanufacturing method comprising:
preparing the used ink refill container;
detaching the nozzle part from the container main body part;
removing the first bag from the container main body part;
filling the second bag with ink; and
attaching the nozzle part to the container main body part,
wherein the attaching includes attaching the container main body part and the nozzle part to each other via the second bag and the elastic part.

19. The ink refill container remanufacturing method according to claim 17, wherein the elastic part is provided on the nozzle part.

20. The ink refill container remanufacturing method according to claim 17, wherein the elastic part is provided on the container main body part.
